(19) United States
(12) Patent Application Publication
(10) Pub. No.: US 2019/0075312 A1
(43) Pub. Date: Mar. 7, 2019

(54) METHOD AND APPARATUS FOR DECODING MULTI-LEVEL VIDEO BITSTREAM

(71) Applicant: MEDIATEK INC., Hsin-Chu (TW)

(72) Inventors: Yung-Chang Chang, Hsin-Chu (TW); Chia-Yun Cheng, Hsin-Chu (TW); Chih-Ming Wang, Hsin-Chu (TW); Meng-Jye Hu, Hsin-Chu (TW); Cheng-Han Li, Hsin-Chu (TW)

(21) Appl. No.: 16/124,170

(22) Filed: Sep. 6, 2018

Related U.S. Application Data
(60) Provisional application No. 62/555,149, filed on Sep. 7, 2017.

(51) Int. Cl. H04N 19/44; H04N 19/30; H04N 19/68

(52) U.S. Cl. CPC H04N 19/44; H04N 19/68; H04N 19/30

(57) ABSTRACT

A video decoding method is used for decoding a multi-plane video bitstream. The multi-plane video bitstream includes a first video subset bitstream corresponding to a fundamental plane (FP) and at least one second video subset bitstream corresponding to at least one augmented plane (AP). The video decoding method includes decoding the first video subset bitstream, decoding the at least one second video subset bitstream, and performing resampling of one decoded FP frame to generate one resampled frame. Decoding the first video subset bitstream includes performing decoding of a first FP frame to generate a first decoded FP frame. Decoding the at least one second video subset bitstream includes performing decoding of a first AP frame to generate a first decoded AP frame. A processing time of performing decoding of the first FP frame overlaps a processing time of performing resampling of said one decoded FP frame.

### CROSS REFERENCE TO RELATED APPLICATIONS

This application claims the benefit of U.S. provisional application No. 62/555,149, filed on 9/7/2017 and incorporated herein by reference.

### BACKGROUND

The present invention relates to decoding video frames, and more particularly, to a method and an apparatus for decoding a multi-level video bitstream.

The conventional video coding standards generally adopt a block based (or coding unit based) coding technique to exploit spatial redundancy and temporal redundancy. For example, the basic approach is to divide the whole source frame into a plurality of blocks (coding units), perform prediction on each block (coding unit), transform residues of each block (coding unit), and perform quantization and entropy encoding. Besides, a reconstructed frame is generated in a coding loop to provide reference pixel data used for coding following blocks (coding units). For certain video coding standards, in-loop filter(s) may be used for enhancing the image quality of the reconstructed frame. A video encoder is used to encode video frames into a bitstream for transmission or storage. A video decoder can be used to decode the bitstream generated from the video encoder to obtain decoded video frames.

Development of video compression is of high importance with the increased use of video. Having an effective compression of video will affect both storage space needed and transmission bandwidth used. There is a large variety of video playback devices today, with a great diversity in screen size, bandwidth and processing power. One multi-level video bitstream, including one video subset bitstream corresponding to a fundamental plane and at least one video subset bitstream corresponding to at least one augmented plane, can be generated from a video source device to meet different playback requirements (e.g., different screen sizes and/or different computing capabilities) of video playback devices. There is a need for an innovative video decoding design that is capable of decoding the multi-level video bitstream in an efficient way.

### SUMMARY

One of the objectives of the claimed invention is to provide a method and an apparatus for decoding a multi-level video bitstream.

According to a first aspect of the present invention, an exemplary video decoding method for decoding a multi-plane video bitstream is disclosed. The multi-plane video bitstream includes a first video subset bitstream corresponding to a fundamental plane (FP) and at least one second video subset bitstream corresponding to at least one augmented plane (AP). The exemplary video decoding method includes: decoding the first video subset bitstream, wherein decoding of a first FP frame is performed to generate a first decoded FP frame; performing resampling of one decoded FP frame to generate one resampled frame, wherein said one resampled frame serves as one reference frame for decoding one AP frame; and decoding said at least one second video subset bitstream, wherein decoding of a first AP frame is performed to generate a first decoded AP frame. A processing time of performing decoding of the first FP frame overlaps a processing time of performing resampling of said one decoded FP frame.

According to a second aspect of the present invention, an exemplary video decoding method for decoding a multi-plane video bitstream is disclosed. The multi-plane video bitstream includes a first video subset bitstream corresponding to a fundamental plane (FP) and at least one second video subset bitstream corresponding to at least one augmented plane (AP). The exemplary video decoding method includes: decoding the first video subset bitstream, wherein decoding of a first FP frame is performed to generate a first decoded FP frame; performing resampling of one decoded FP frame to generate one resampled frame, wherein said one resampled frame serves as one reference frame for decoding one AP frame; and decoding said at least one second video subset bitstream, wherein decoding of a first AP frame is performed to generate a first decoded AP frame. A processing time of performing decoding of the first AP frame overlaps a processing time of performing resampling of said one decoded FP frame.

According to a third aspect of the present invention, an exemplary video decoding apparatus for decoding a multi-plane video bitstream is disclosed. The exemplary multi-plane video bitstream includes a first video subset bitstream corresponding to a fundamental plane (FP) and at least one second video subset bitstream corresponding to at least one augmented plane (AP). The exemplary video decoding apparatus includes a video decoding circuit and a resampling circuit. The video decoding circuit is arranged to decode the first video subset bitstream, wherein decoding of a first FP frame is performed to generate a first decoded FP frame. The video decoding circuit is further arranged to decode said at least one second video subset bitstream, wherein decoding of a first AP frame is performed to generate a first decoded AP frame. The resampling circuit is arranged to perform resampling of one decoded FP frame to generate one resampled frame, wherein said one resampled frame serves as one reference frame for decoding one AP frame. A processing time of performing resampling of said one decoded FP frame overlaps at least one selected from a group of a processing time of performing decoding of the first FP frame and a processing time of performing decoding of the first AP frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video decoding apparatus according to an embodiment of the present invention.

FIG. 2 is a diagram illustrating a decoding order of FP frames and AP frames according to an embodiment of the present invention.

FIG. 3 is a diagram illustrating a video decoding circuit implemented using a single hardware video decoder according to an embodiment of the present invention.

FIG. 4 is a diagram illustrating video decoder architecture according to an embodiment of the present invention.

FIG. 5 is a diagram illustrating a first decoding operation of a multi-level video bitstream that is performed by using a single video decoder according to an embodiment of the present invention.

FIG. 6 is a diagram illustrating a second decoding operation of a multi-level video bitstream that is performed by using a single video decoder according to an embodiment of the present invention.

FIG. 7 is a diagram illustrating a video decoding circuit implemented using multiple hardware video decoders according to an embodiment of the present invention.

FIG. 8 is a diagram illustrating a first decoding operation of a multi-level video bitstream that is performed by using multiple video decoders according to an embodiment of the present invention.

FIG. 9 is a diagram illustrating a second decoding operation of a multi-level video bitstream that is performed by using multiple video decoders according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

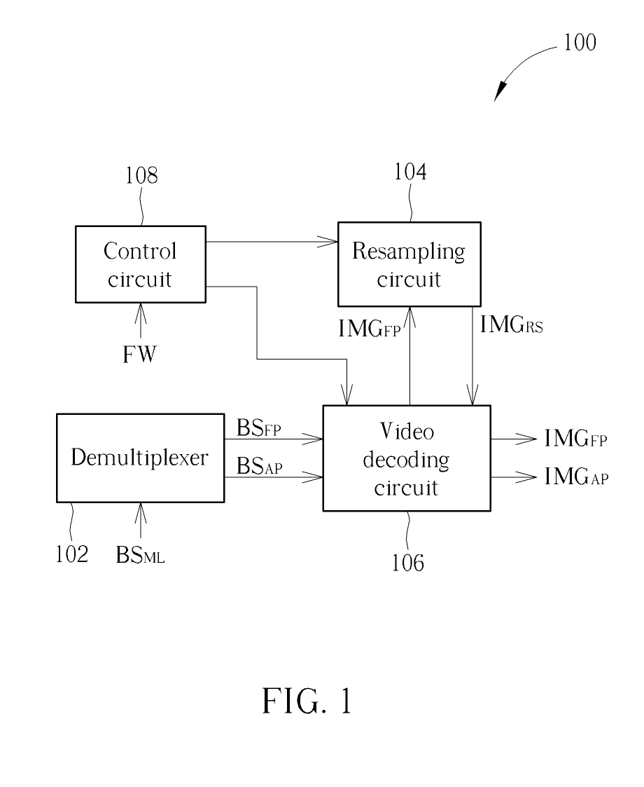

FIG. 1 is a diagram illustrating a video decoding apparatus according to an embodiment of the present invention. The video decoding apparatus 100 includes a demultiplexer 102, a resampling circuit 104, a video decoding circuit 106, and a control circuit 108. The video decoding apparatus 100 is used for decoding a multi-plane video bitstream BS_{ML}. For example, the multi-plane video bitstream BS_{ML} may be delivered via digital television (DTV) broadcast, and the video decoding apparatus 100 may be a part of a DTV chip. The multi-plane video bitstream BS_{ML} includes a first video subset bitstream BS_{FP} corresponding to a fundamental plane (FP) and at least one second video subset bitstream BS_{AP} corresponding to at least one augmented plane (AP). For clarity and simplicity, the multi-plane video bitstream BS_{ML} is shown having a single second video subset bitstream for only one augmented plane. In practice, the multi-plane video bitstream BS_{ML} may include a plurality of second video subset bitstreams corresponding to a plurality of augmented planes, respectively.

The demultiplexer 102 is arranged to apply demultiplexing to the first video subset bitstream BS_{FP} and the second video subset bitstream BS_{AP} multiplexed in the same multi-plane video bitstream BS_{ML}. For example, a video content carried by the first video subset bitstream BS_{FP} and a video content carried by the second video subset bitstream BS_{AP} may have different resolutions (i.e., different frame sizes), different frame rates, different signal-to-noise ratios (i.e., different quality), different color formats, and/or different bit depths.

The video decoding circuit 106 is arranged to decode the first video subset bitstream BS_{FP} to generate decoded FP frames IMG_{FP} on the fundamental plane. The video decoding circuit 106 is further arranged to decode the second video subset bitstream BS_{AP} to generate decoded AP frames IMG_{AP} on the augmented plane. In some embodiments of the present invention, each FP frame decoded from the first video subset bitstream BS_{FP} has a first resolution, and each AP frame decoded from the second video subset bitstream BS_{AP} has a second resolution, where the first resolution is smaller than the second resolution. For example, the first resolution may be a Full High Definition (FHD) resolution, and the second resolution may be an Ultra High Definition (UHD) resolution.

The decoded FP frame IMG_{FP} can be used to generate a reference frame used by prediction involved in decoding of one AP frame. The resampling circuit 104 is arranged to performing resampling of one decoded FP frame IMG_{FP} to generate one resampled frame IMG_{RS}, wherein the resampled frame IMG_{RS} serves as one reference frame for decoding one AP frame. For example, a video content carried by the first video subset bitstream BS_{FP} and a video content carried by the second video subset bitstream BS_{AP} may have different resolutions and/or different bit depths. The resampling circuit 104 resamples the decoded FP frame IMG_{FP} on the fundamental plane to generate the resampled frame IMG_{FP} having the same resolution and bit depth possessed by the AP frame on the augmented plane. In other words, the resampled frame IMG_{F P}and the decoded AP frame IMG_{AP} have the same resolution and bit depth. Moreover, the motion vector (MV) information involved in generating the decoded FP frame IMG_{FP} may be resampled by the resampling circuit 104 for AP temporal MV prediction.

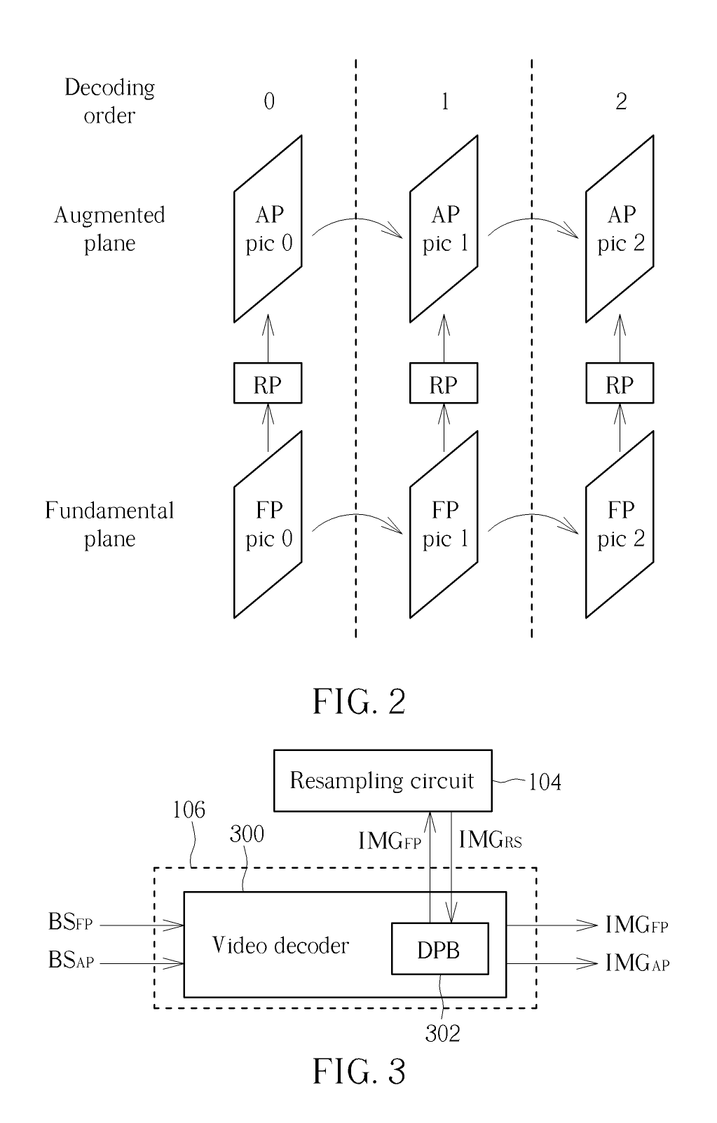

Since a decoded FP frame generated from decoding an FP frame is resampled to serve as a reference frame that can be used for decoding an AP frame to generate a decoded AP frame, there is dependency between decoding of an FP frame and resampling of a decoded FP frame and dependency between resampling of a decoded FP frame and decoding of an AP frame. For example, a resampling process (RP) is performed after decoding of an FP frame. For another example, the RP is performed before decoding of an AP frame. FIG. 2 is a diagram illustrating a decoding order of FP frames and AP frames according to an embodiment of the present invention. For clarity and simplicity, it is assumed that the multi-level video bitstream BS_{ML} consists of one first video subset bitstream BS_{FP} corresponding to the fundamental plane and one second video subset bitstream BS_{AP} corresponding to one augmented plane. Concerning the fundamental plane, an FP frame “FP pic 0” with the decoding order “0” is decoded earlier than an FP frame “FP pic 1” with the decoding order “1”, and the FP frame “FP pic 1” with the decoding order “1” is decoded earlier than an FP frame “FP pic 2” with the decoding order “2”. Concerning the augmented plane, an AP frame “AP pic 0” with the decoding order “0” is decoded earlier than an AP frame “AP pic 1” with the decoding order “1”, and the AP frame “AP pic 1” with the decoding order “1” is decoded earlier than an AP frame “AP pic 2” with the decoding order “2”. In addition, a decoded FP frame (which is a decoding result of the FP frame “FP pic 0”) is processed by a resampling process to generate a resampled frame serving as a reference frame for decoding the AP frame “AP pic 0”; a decoded FP frame (which is a decoding result of the FP frame “FP pic 1”) is processed by a resampling process to generate a resampled frame serving as a reference frame for decoding the AP frame “AP pic 1”; and a decoded FP frame (which is a decoding result of the FP frame “FP pic 2”) is processed by a resampling process to generate a resampled frame serving as a reference frame for decoding the AP frame “AP pic 2”.

If a resampling process of a decoding result of an FP frame (e.g., “FP pic 0”) on the fundamental plane does not start until a decoding process of the FP frame (e.g., “FP pic 0”) on the fundamental plane is completed and a decoding process of an AP frame (e.g., “AP pic 0”) on the augmented plane does not start until the resampling process of the decoding result of the FP frame (e.g., “FP pic 0”) on the fundamental plane is completed, the decoding time needed to obtain one decoded FP frame and one AP decoded frame is roughly equal to T_{FP}+T_{RP}+T_{AP}, where T_{FP} is FP decoding time, T_{RP} is RP processing time, and T_{AP} is AP decoding time. To effectively reduce the decoding time, the present invention proposes a parallel processing scheme for decoding the multi-level video bitstream BS_{ML}.

The parallel processing scheme is managed by the control circuit 108. In this embodiment, the control circuit 108 is arranged to control operations of the video decoding circuit 106 and the resampling circuit 104. For example, the control circuit 108 is arranged to trigger a decoding process of one FP frame, a decoding process of one AP frame, and a resampling process of one decoded FP frame. For example, the control circuit 108 may be a processor, and operations of the video decoding circuit 106 and the resampling circuit 104 may be managed by firmware FW running on the control circuit 108. Decoding the first video subset bitstream BS_{FP} includes performing decoding of one FP frame to generate one decoded FP frame IMG_{FP}. Decoding the second video subset bitstream BS_{AP} includes performing decoding of one AP frame to generate one decoded AP frame IMG_{AP}. When the parallel processing scheme is enabled by the control circuit 108, a processing time of performing resampling of one decoded FP frame overlaps at least one selected from a group of a processing time of performing decoding of one FP frame and a processing time of performing decoding of one AP frame. For example, a processing time of performing resampling of one decoded FP frame overlaps a processing time of performing decoding of one FP frame. For another example, a processing time of performing resampling of one decoded FP frame overlaps a processing time of performing decoding of one AP frame. For yet another example, a processing time of performing resampling of one decoded FP frame overlaps a processing time of performing decoding of one FP frame, and further overlaps a processing time of performing decoding of one AP frame. It should be noted that the term “overlap” may mean a processing time of one operation is fully hidden in a processing time of another operation, or a processing time of one operation is partially hidden in a processing time of another operation.

In one exemplary design, the video decoding circuit 106 shown in FIG. 1 may be implemented using a single hardware video decoder. FIG. 3 is a diagram illustrating a video decoding circuit implemented using a single hardware video decoder according to an embodiment of the present invention. As mentioned above, the video decoding circuit 106 is arranged to decode the first video subset bitstream BS_{FP} and the second video subset bitstream BS_{AP}, where decoding the first video subset bitstream BS_{FP} includes performing decoding of one FP frame to generate one decoded FP frame, and decoding the second video subset bitstream BS_{AP} includes performing decoding of one AP frame to generate one decoded AP frame. Since the video decoding circuit 106 is implemented using a single hardware video decoder, the video decoder 300 is used for performing decoding of one FP frame, and is re-used for performing decoding of one AP frame. For example, the same block-level logic can be shared between FP frame decoding and AP frame decoding. The video decoder 300 has a decoded picture buffer (DPB) 302. The DPB 302 is used for buffering decoded FP frames IMG_{FP} that can be used as reference frames for decoding FP frames, and is further used for buffering decoded AP frames IMG_{AP} and resampled frames IMG_{RS} that can be used as reference frames for decoding AP frames.

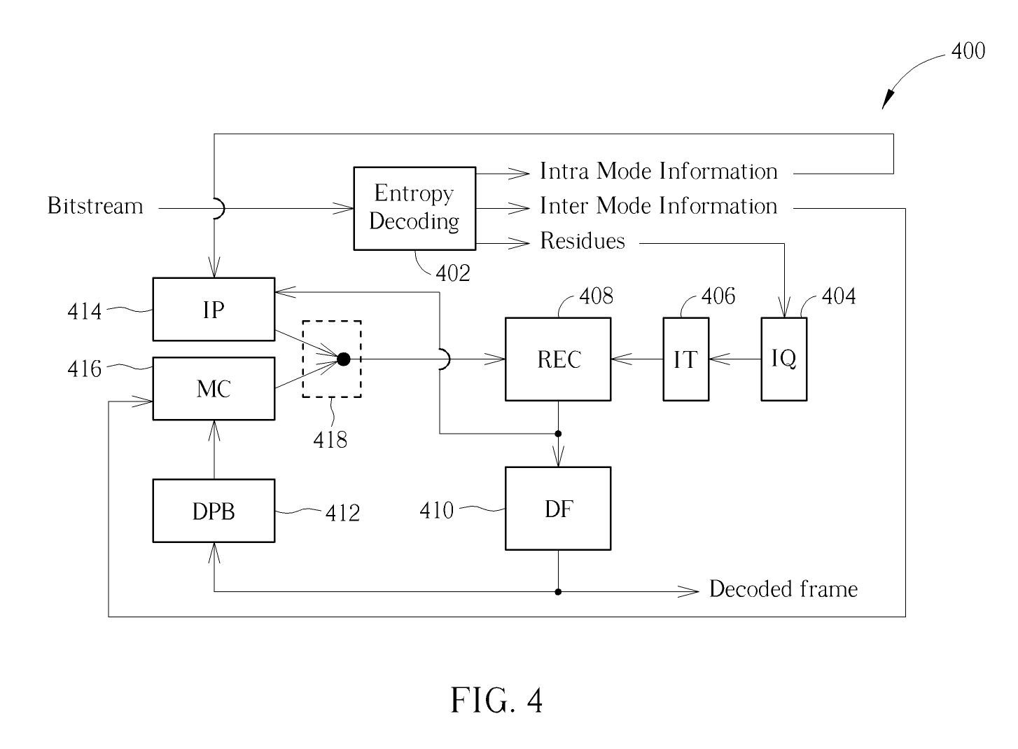

FIG. 4 is a diagram illustrating video decoder architecture according to an embodiment of the present invention. The video decoder 300 shown in FIG. 3 may be configured to have the video decoder architecture 400 shown in FIG. 4. It should be noted that the video decoder architecture shown in FIG. 4 is for illustrative purposes only, and is not meant to be a limitation of the present invention. For example, different video decoder architecture may be used under different coding standards, respectively. In this embodiment, the video decoder architecture 400 includes an entropy decoding circuit (denoted by “Entropy Decoding”) 402, an inverse quantization circuit (denoted by “IQ”) 404, an inverse transform circuit (denoted by “IT”) 406, a reconstruction circuit (denoted by “REC”) 408, at least one in-loop filter (e.g., a deblocking filter (DF) 410), a decoded picture buffer (DPB) 412, an intra prediction circuit (denoted by “IP”) 414, a motion compensation circuit (denoted by “MC”) 416, and a mode selection circuit 418. In a case where a block is encoded under an intra prediction mode, the intra mode information parsed from the bitstream is provided to the intra prediction circuit 414, and the intra prediction circuit 414 outputs predicted samples of the block to the reconstruct circuit 408 via the mode selection circuit 418. In another case where a block is encoded under an inter prediction mode, the inter mode information parsed from the bitstream is provided to the motion compensation circuit 416, and the motion compensation circuit 416 outputs predicted samples of the block to the reconstruct circuit 408 via the mode selection circuit 418. The residues generated from entropy decoding of the bitstream are provided to the reconstruct circuit 408 through the inverse quantization circuit 404 and the inverse transform circuit 406. A reconstructed frame output from the reconstruct circuit 408 is stored into the decoded picture buffer 412 as a reference frame through the deblocking filter 410. Since basic functions and operations of these functional blocks in the video decoder architecture 400 are well known to those skilled in the pertinent art, further description is omitted here for brevity.

The video decoder 300 with the video decoder architecture 400 can be managed by the control circuit 108 to perform FP frame decoding and AP frame decoding in a time-division manner. When the bitstream to be decoded is a part of the first video subset bitstream BS_{FP} that is output from the demultiplexer 102, the video decoder architecture 400 is used to decode the part of the first video subset bitstream BS_{FP} to generate one decoded frame being a decoded FP frame IMG_{FP}, where the decoded FP frame IMG_{FP} is stored into the DPB 412 and can be used as a reference frame for decoding FP frame(s). When the bitstream to be decoded is a part of the second video subset bitstream BS_{AP} that is output from the demultiplexer 102, the video decoder architecture 400 is re-used to decode the part of the second video subset bitstream BS_{AP} to generate one decoded frame being a decoded AP frame IMG_{AP}, where the decoded AP frame IMG_{AP} is stored into the DPB 412 and can be used as a reference frame for decoding AP frame(s). Moreover, after the decoded FP frame IMG_{FP} is stored into the DPB 412, the resampling circuit 104 reads the decoded FP frame IMG_{FP} from the DPB 412, resamples the decoded FP frame IMG_{FP} to generate a resampled frame IMG_{RS}, and stores the resampled frame IMG_{RS} into the DPB 412, where the resampled frame IMG_{RS} can be used as a reference frame for decoding one AP frame.

Regarding the video decoding circuit 106 implemented using a single hardware video decoder, a parallel processing scheme can be managed by the control circuit 108 to effectively reduce the decoding time. For example, the decoding time can be reduced by allowing a resampling process of a decoded FP frame to start before an end of a decoding process of an FP frame that is used for generating the decoded FP frame, and/or allowing a decoding process of an AP frame to start before an end of the resampling process of the decoded FP frame. In this way, the decoding time needed to obtain one decoded FP frame and one AP decoded frame is less than T_{FP}+T_{RP}+T_{AP}, where T_{FP} is FP decoding time, T_{RP} is RP processing time, and T_{AP} is AP decoding time.

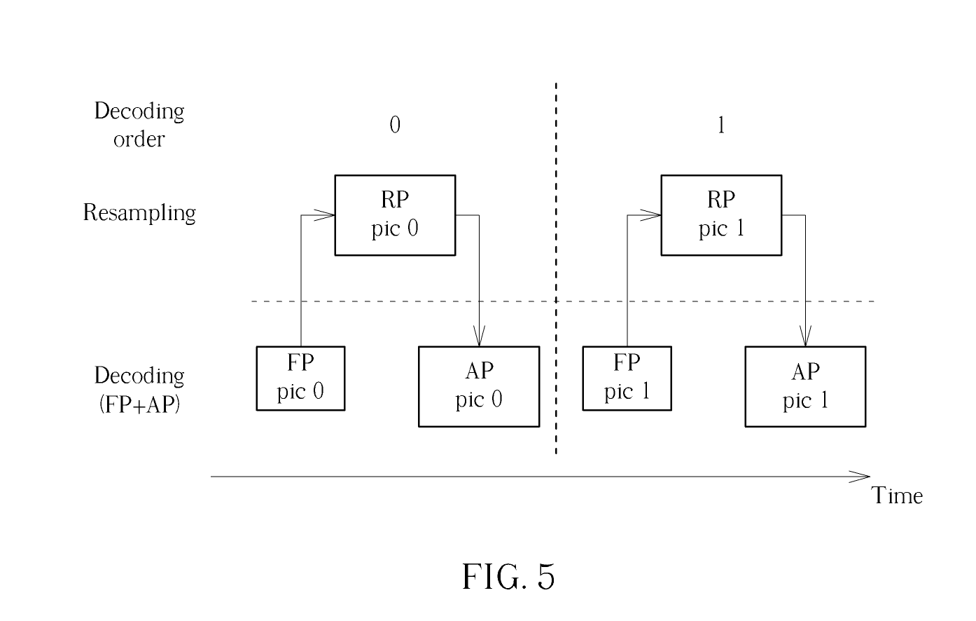

FIG. 5 is a diagram illustrating a first decoding operation of a multi-level video bitstream that is performed by using a single video decoder according to an embodiment of the present invention. The decoding operation shown in FIG. 5 may be achieved by using the resampling circuit 104 and the video decoder 300 shown in FIG. 3, where a decoding process of an FP frame and a decoding process of an AP frame are performed by the same video decoder 300, and a resampling process of a decoded FP frame is performed by the resampling circuit 104. In this example, the resampling circuit 104 can start a resampling process of a decoded FP frame (which is derived from a decoding process of an FP frame “FP pic 0”) before the decoding process of the FP frame “FP pic 0” is completed, and the video decoder 300 can start a decoding process of an AP frame “AP pic 0” (which uses the resampled frame “RP pic 0” as a reference frame) before the resampling process of the decoded FP frame (which is derived from the decoding process of the FP frame “FP pic 0”) is completed. Hence, a portion of a resampled frame “RP pic 0” is generated by resampling a portion of the decoded FP frame (which is derived from the decoding process of the FP frame “FP pic 0”) before the decoding process of the FP frame “FP pic 0” is completed, and a portion of a decoded AP frame (which is derived from the decoding process of the AP frame “AP pic 0”) is generated before the resampling process of the decoded FP frame (which is derived from the decoding process of the FP frame “FP pic 0”) is completed.

Similarly, the resampling circuit 104 can start a resampling process of a decoded FP frame (which is derived from a decoding process of an FP frame “FP pic 1”) before the decoding process of the FP frame “FP pic 1” is completed, and the video decoder 300 can start a decoding process of an AP frame “AP pic 1” (which uses the resampled frame “RP pic 1” as a reference frame) before the resampling process of the decoded FP frame (which is derived from the decoding process of the FP frame “FP pic 1”) is completed. Hence, a portion of a resampled frame “RP pic 1” is generated by resampling a portion of the decoded FP frame (which is derived from the decoding process of the FP frame “FP pic 1”) before the decoding process of the FP frame “FP pic 1” is completed, and a portion of a decoded AP frame (which is derived from the decoding process of the AP frame “AP pic 1”) is generated before the resampling process of the decoded FP frame (which is derived from the decoding process of the FP frame “FP pic 1”) is completed.

Regarding the decoding time reduction scheme shown in FIG. 5, a processing time of a resampling process of an N^{th} decoded FP frame can be partially hidden in a processing time of a decoding process of an N^{th} FP frame and/or a processing time of a decoding process of an N^{th} AP frame, where N≥0. However, this is for illustrative purposes only, and is not meant to be a limitation of the present invention. Alternatively, a processing time of a resampling process of an N^{th} decoded FP frame can be partially/fully hidden in a processing time of a decoding process of an (N+1)^{th} FP frame, where N=0; and a processing time of a resampling process of an N^{th} decoded FP frame can be partially/fully hidden in a processing time of a decoding process of an (N−1)^{th} AP frame, where N≥1.

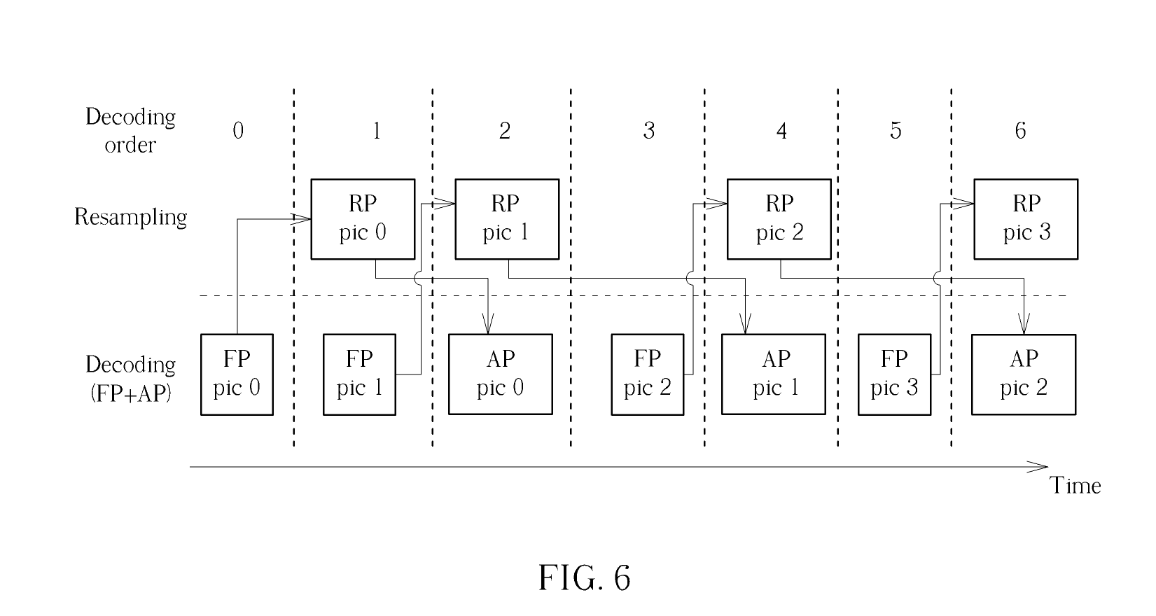

FIG. 6 is a diagram illustrating a second decoding operation of a multi-level video bitstream that is performed by using a single video decoder according to an embodiment of the present invention. The decoding operation shown in FIG. 6 may be achieved by using the resampling circuit 104 and the video decoder 300 shown in FIG. 3, where a decoding process of an FP frame and a decoding process of an AP frame are performed by the same video decoder 300, and a resampling process of a decoded FP frame is performed by the resampling circuit 104. In this example, the video decoder 300 decodes one FP frame “FP pic 0” in advance, and then decodes one (M+1)^{th} FP frame and one M^{th} AP frame in an interleaved order, where M≥0. In addition, a processing time of a resampling process of an N^{th} decoded FP frame (which is derived from a decoding process of an N^{th} FP frame) can be partially/fully hidden in a processing time of a decoding process of the (N+1)^{th} FP frame, where N=0; and a processing time of a resampling process of an N^{th} decoded FP frame (which is derived from a decoding process of an N^{th} FP frame) can be partially/fully hidden in a processing time of a decoding process of the (N−1)^{th} AP frame, where N≥1.

As shown in FIG. 6, a processing time of a decoding process of an FP frame “FP pic 1” overlaps a processing time of a resampling process of a decoded frame that is used for generating a resampled frame “RP pic 0”, a processing time of a decoding process of an AP frame “AP pic 0” (which uses the resampled frame “RP pic 0” as a reference frame) overlaps a processing time of a resampling process of a decoded frame that is used for generating a resampled frame “RP pic 1”, a processing time of a decoding process of an AP frame “AP pic 1” (which uses the resampled frame “RP pic 1” as a reference frame) overlaps a processing time of a resampling process of a decoded frame that is used for generating a resampled frame “RP pic 2”, and a processing time of a decoding process of an AP frame “AP pic 2” (which uses the resampled frame “RP pic 2” as a reference frame) overlaps a processing time of a resampling process of a decoded frame that is used for generating a resampled frame “RP pic 3”.

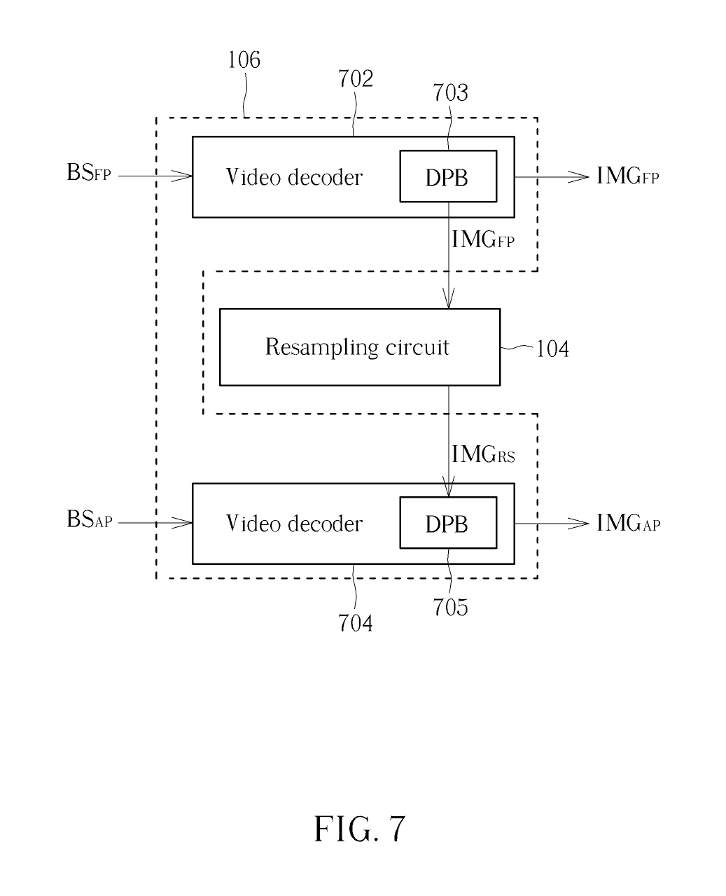

In another exemplary design, the video decoding circuit 106 shown in FIG. 1 may be implemented using multiple hardware video decoders. FIG. 7 is a diagram illustrating a video decoding circuit implemented using multiple hardware video decoders according to an embodiment of the present invention. As mentioned above, the video decoding circuit 106 is arranged to decode the first video subset bitstream BS_{FP} and the second video subset bitstream BS_{AP}, where decoding the first video subset bitstream BS_{FP} includes performing decoding of one FP frame to generate one decoded FP frame, and decoding the second video subset bitstream BS_{AP} includes performing decoding of one AP frame to generate one decoded AP frame. The video decoding circuit 106 is implemented by separate video decoders, including a video decoder 702 acting as an FP decoder for performing decoding of FP frames and a video decoder 704 acting as an AP decoder for performing decoding of AP frames. For example, the same block-level logic can be used in each of the video decoders 702 and 704. The video decoder 702 has a decoded picture buffer (DPB) 703. The DPB 703 can be used for buffering decoded FP frames that can be used as reference frames for decoding FP frames. The video decoder 704 has a decoded picture buffer (DPB) 705. The DPB 705 can be used for buffering decoded AP frames IMG_{AP} and resampled frames IMG_{RS} that can be used as reference frames for decoding AP frames.

In some embodiments of the present invention, each of the video decoders 702 and 704 shown in FIG. 7 may be configured to have the same video decoder architecture 400 shown in FIG. 4. It should be noted that the video decoder architecture shown in FIG. 4 is for illustrative purposes only, and is not meant to be a limitation of the present invention. For example, different video decoder architecture may be used under different coding standards, respectively. The video decoder 702 with the video decoder architecture 400 can be managed by the control circuit 108 to perform FP frame decoding. As shown in FIG. 4, the bitstream to be decoded is a part of the first video subset bitstream BS_{FP} that is output from the demultiplexer 102. Hence, the video decoder architecture 400 is used to decode the part of the first video subset bitstream BS_{FP} to generate one decoded frame being a decoded FP frame IMG_{FP}, where the decoded FP frame IMG_{FP} is stored into the DPB 412 and can be used as a reference frame for decoding FP frame(s).

In addition, the video decoder 704 with the video decoder architecture 400 can be managed by the control circuit 108 to perform AP decoding. As shown in FIG. 4, the bitstream to be decoded is a part of the second video subset bitstream BS_{AP} that is output from the demultiplexer 102. Hence, the video decoder architecture 400 is used to decode the part of the second video subset bitstream BS_{AP} to generate one decoded frame being a decoded AP frame IMG_{AP}, where the decoded AP frame IMG_{AP} is stored into the DPB 412 and can be used as a reference frame for decoding AP frame(s).

Compared to the DPB 703 of the video decoder 702, the DPB 705 of the video decoder 704 further store resampled frames IMG_{RS} generated from resampling decoded FP frames IMG_{FP}. Hence, after the decoded FP frame IMG_{FP} is stored into the DPB 703, the resampling circuit 104 reads the decoded FP frame IMG_{FP} from the DPB 703, resamples the decoded FP frame IMG_{FP} to generate a resampled frame IMG_{RS}, and stores the resampled frame IMG_{RS} into the DPB 705, where the resampled frame IMG_{RS} stored in the DPB 705 can be used as a reference frame for decoding one AP frame.

Regarding the video decoding circuit 106 implemented using multiple hardware video decoders, a parallel processing scheme can be managed by the control circuit 108 to effectively reduce the decoding time. For example, the decoding time can be reduced by allowing a resampling process of a decoded FP frame to start before an end of a decoding process of an FP frame that is used for generating the decoded FP frame, and/or allowing a decoding process of an AP frame to start before an end of the resampling process of the decoded FP frame. In this way, the decoding time needed to obtain one decoded FP frame and one AP decoded frame is less than T_{FP}+T_{RP}+T_{AP}, where T_{FP} is FP decoding time, T_{RP} is RP processing time, and T_{AP} is AP decoding time.

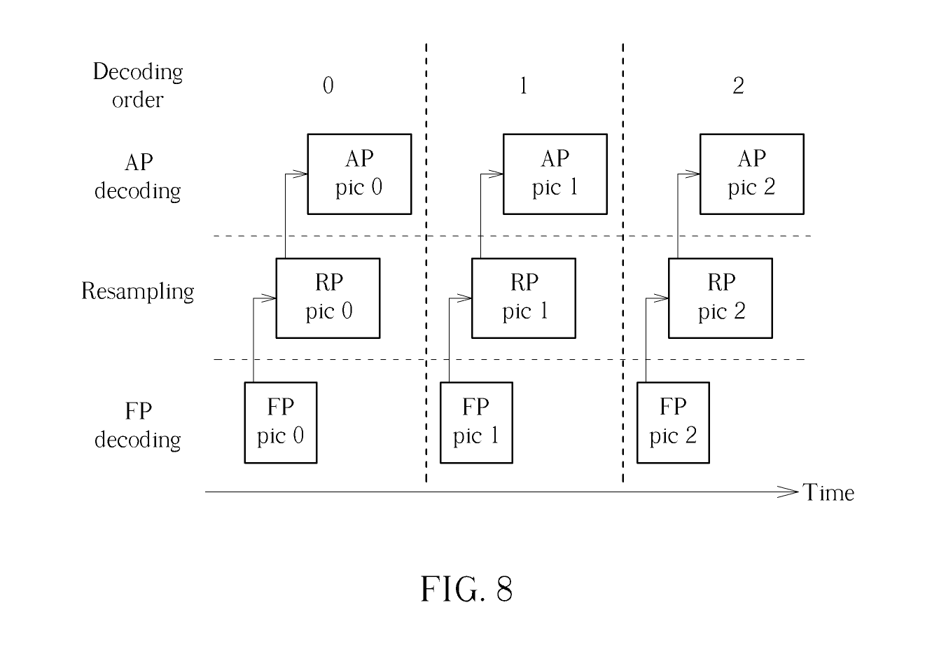

FIG. 8 is a diagram illustrating a first decoding operation of a multi-level video bitstream that is performed by using multiple video decoders according to an embodiment of the present invention. The decoding operation shown in FIG. 8 may be achieved by using the resampling circuit 104 and the video decoders 702 and 704 shown in FIG. 7, where a decoding process of an FP frame is performed by the video decoder 702, a decoding process of an AP frame is performed by the video decoder 704, and a resampling process of a decoded FP frame is performed by the resampling circuit 104. In this example, the resampling circuit 104 can start a resampling process of a decoded FP frame (which is derived from a decoding process of an FP frame “FP pic 0”) before the decoding process of the FP frame “FP pic 0” is completed, and the video decoder 704 can start a decoding process of an AP frame “AP pic 0” (which uses a resampled frame “RP pic 0” as a reference frame) before the resampling process of the decoded FP frame (which is derived from the decoding process of the FP frame “FP pic 0”) is completed. Hence, a portion of the resampled frame “RP pic 0” is generated by resampling a portion of the decoded FP frame (which is derived from the decoding process of the FP frame “FP pic 0”) before the decoding process of the FP frame “FP pic 0” is completed, and a portion of a decoded AP frame (which is derived from the decoding process of the AP frame “AP pic 0”) is generated before the resampling process of the decoded FP frame (which is derived from the decoding process of the FP frame “FP pic 0”) is completed.

In addition, the resampling circuit 104 can start a resampling process of a decoded FP frame (which is derived from a decoding process of an FP frame “FP pic 1”) before the decoding process of the FP frame “FP pic 1” is completed, and the video decoder 704 can start a decoding process of an AP frame “AP pic 1” (which uses a resampled frame “RP pic 1” as a reference frame) before the resampling process of the decoded FP frame (which is derived from the decoding process of the FP frame “FP pic 1”) is completed. Hence, a portion of the resampled frame “RP pic 1” is generated by resampling a portion of the decoded FP frame (which is derived from the decoding process of the FP frame “FP pic 1”) before the decoding process of the FP frame “FP pic 1” is completed, and a portion of a decoded AP frame (which is derived from the decoding process of the AP frame “AP pic 1”) is generated before the resampling process of the decoded FP frame (which is derived from the decoding process of the FP frame “FP pic 1”) is completed.

Similarly, the resampling circuit 104 can start a resampling process of a decoded FP frame (which is derived from a decoding process of an FP frame “FP pic 2”) before the decoding process of the FP frame “FP pic 2” is completed, and the video decoder 704 can start a decoding process of an AP frame “AP pic 2” (which uses a resampled frame “RP pic 2” as a reference frame) before the resampling process of the decoded FP frame (which is derived from the decoding process of the FP frame “FP pic 2”) is completed. Hence, a portion of the resampled frame “RP pic 2” is generated by resampling a portion of the decoded FP frame (which is derived from the decoding process of the FP frame “FP pic 2”) before the decoding process of the FP frame “FP pic 2” is completed, and a portion of a decoded AP frame (which is derived from the decoding process of the AP frame “AP pic 2”) is generated before the resampling process of the decoded FP frame (which is derived from the decoding process of the FP frame “FP pic 2”) is completed.

Regarding the decoding time reduction scheme shown in FIG. 8, a processing time of a resampling process of an N^{th} decoded FP frame can be partially hidden in a processing time of a decoding process of an N^{th} FP frame and/or a processing time of a decoding process of an N^{th} AP frame, where N≥0. However, this is for illustrative purposes only, and is not meant to be a limitation of the present invention. Alternatively, a processing time of a resampling process of an N^{th} decoded FP frame can be partially/fully hidden in a processing time of a decoding process of an (N+1)^{th} FP frame, where N≥0; and a processing time of a resampling process of an N^{th} decoded FP frame can be partially/fully hidden in a processing time of a decoding process of an (N−1)^{th} AP frame, where N≥1.

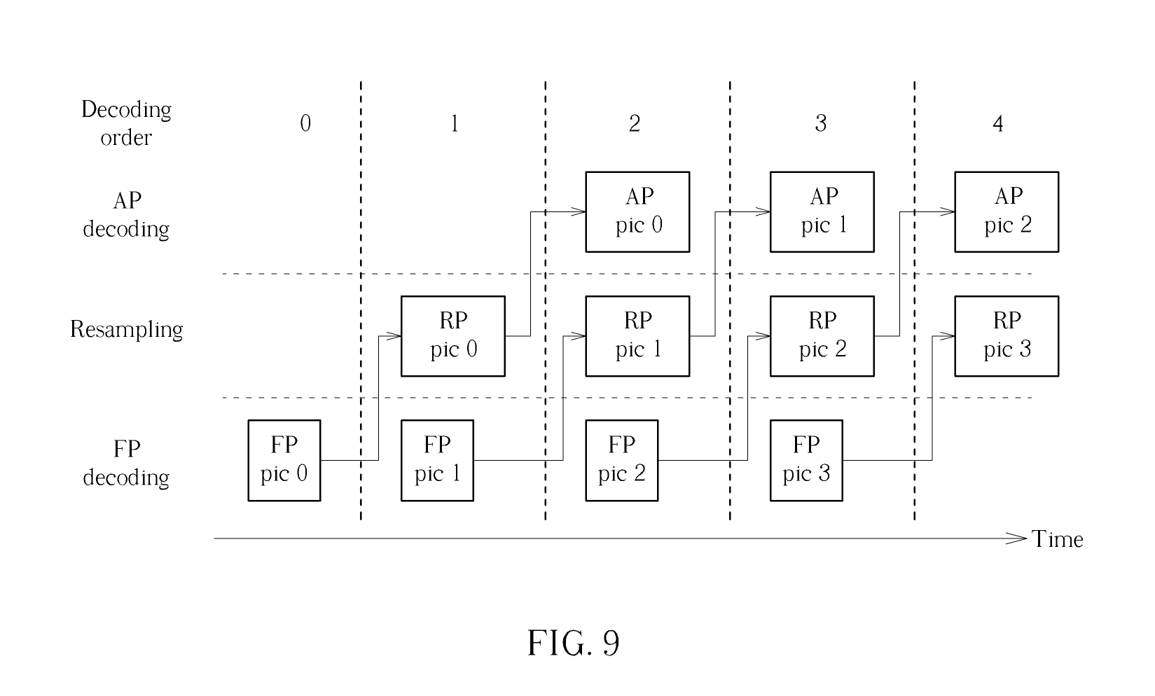

FIG. 9 is a diagram illustrating a second decoding operation of a multi-level video bitstream that is performed by using multiple video decoders according to an embodiment of the present invention. The decoding operation shown in FIG. 9 may be achieved by using the resampling circuit 104 and the video decoders 702 and 704 shown in FIG. 7, where a decoding process of an FP frame is performed by the video decoder 702, a decoding process of an AP frame is performed by the video decoder 704, and a resampling process of a decoded FP frame is performed by the resampling circuit 104. In this example, the video decoder 702 decodes two FP frames in advance, and then the video decoder 704 starts to decode one AP frame, such that the video decoder 702 decodes one FP frame and the video decoder 704 decodes one AP frame in a parallel processing manner. In addition, a processing time of a resampling process of an N^{th} decoded FP frame (which is derived from a decoding process of an N^{th} FP frame) can be partially/fully hidden in a processing time of a decoding process of the (N+1)^{th} FP frame, where N≥0; and a processing time of a resampling process of an N^{th} decoded FP frame (which is derived from a decoding process of an N^{th} FP frame) can be partially/fully hidden in a processing time of a decoding process of the (N−1)^{th} AP frame, where N≥1.

As shown in FIG. 9, a processing time of a decoding process of an FP frame “FP pic 1” overlaps a processing time of a resampling process of a decoded frame that is used for generating a resampled frame “RP pic 0”; a processing time of a resampling process of a decoded frame that is used for generating a resampled frame “RP pic 1” overlaps a processing time of a decoding process of an AP frame “AP pic 0” (which uses the resampled frame “RP pic 0” as a reference frame), and further overlaps a processing time of a decoding process of an FP frame “FP pic 2”; a processing time of a resampling process of a decoded frame that is used for generating a resampled frame “RP pic 2” overlaps a processing time of a decoding process of an AP frame “AP pic 1” (which uses the resampled frame “RP pic 1” as a reference frame), and further overlaps a processing time of a decoding process of an FP frame “FP pic 3”; and a processing time of a resampling process of a decoded frame that is used for generating a resampled frame “RP pic 3” overlaps a processing time of a decoding process of an AP frame “AP pic 2” (which uses the resampled frame “RP pic 2” as a reference frame).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video decoding method for decoding a multi-plane video bitstream, the multi-plane video bitstream comprising a first video subset bitstream corresponding to a fundamental plane (FP) and at least one second video subset bitstream corresponding to at least one augmented plane (AP), the video decoding method comprising:
decoding the first video subset bitstream, comprising:
performing decoding of a first FP frame to generate a first decoded FP frame;
performing resampling of one decoded FP frame to generate one resampled frame, wherein said one resampled frame serves as one reference frame for decoding one AP frame; and
decoding said at least one second video subset bitstream, comprising:
performing decoding of a first AP frame to generate a first decoded AP frame;
wherein a processing time of performing decoding of the first FP frame overlaps a processing time of performing resampling of said one decoded FP frame.

2. The video decoding method of claim 1, wherein a single video decoder is used for performing decoding of the first FP frame, and is re-used for performing decoding of the first AP frame.

3. The video decoding method of claim 2, wherein said one decoded FP frame is the first decoded FP frame.

4. The video decoding method of claim 2, wherein decoding the first video subset bitstream further comprises:
performing decoding of a second FP frame to generate a second decoded FP frame, wherein decoding of the second FP frame is earlier than decoding of the first FP frame, and said one decoded FP frame is the second decoded FP frame.

5. The video decoding method of claim 1, wherein a first video decoder is used for performing decoding of the first FP frame, a second video decoder is used for performing decoding of the first AP frame, and the first video decoder and the second video decoder are separate decoders.

6. The video decoding method of claim 5, wherein said one decoded FP frame is the first decoded FP frame.

7. The video decoding method of claim 6, wherein said one AP frame is the first AP frame, and the processing time of performing resampling of said one decoded FP frame further overlaps the processing time of performing decoding of the first AP frame.

8. The video decoding method of claim 5, wherein decoding the first video subset bitstream further comprises:
performing decoding of a second FP frame to generate a second decoded FP frame, wherein decoding of the second FP frame is earlier than decoding of the first FP frame, and said one decoded FP frame is the second decoded FP frame.

9. The video decoding method of claim 8, wherein said one AP frame is the first AP frame, and decoding said at least one second video subset bitstream further comprises:
performing decoding of a second AP frame to generate a second decoded AP frame, wherein decoding of the second AP frame is earlier than decoding of the first AP frame, and the processing time of performing resampling of said one decoded FP frame further overlaps a processing time of performing decoding of the second AP frame.

10. A video decoding method for decoding a multi-plane video bitstream, the multi-plane video bitstream comprising a first video subset bitstream corresponding to a fundamental plane (FP) and at least one second video subset bitstream corresponding to at least one augmented plane (AP), the video decoding method comprising:
decoding the first video subset bitstream, comprising:
performing decoding of a first FP frame to generate a first decoded FP frame;
performing resampling of one decoded FP frame to generate one resampled frame, wherein said one resampled frame serves as one reference frame for decoding one AP frame; and
decoding said at least one second video subset bitstream, comprising:
performing decoding of a first AP frame to generate a first decoded AP frame;
wherein a processing time of performing decoding of the first AP frame overlaps a processing time of performing resampling of said one decoded FP frame.

11. The video decoding method of claim 10, wherein a single video decoder is used for performing decoding of the first FP frame, and is re-used for performing decoding of the first AP frame.

12. The video decoding method of claim 11, wherein said one AP frame is the first AP frame.

13. The video decoding method of claim 11, further comprising:
performing resampling of another decoded FP frame to generate another resampled frame, wherein resampling of said another decoded FP frame is earlier than resampling of said one decoded FP frame, and said another one resampled frame serves as one reference frame for decoding the first AP frame.

14. The video decoding method of claim 10, wherein a first video decoder is used for performing decoding of the first FP frame, a second video decoder is used for performing decoding of the first AP frame, and the first video decoder and the second video decoder are separate decoders.

15. The video decoding method of claim 14, wherein said one decoded FP frame is the first decoded FP frame, and said one AP frame is the first AP frame.

16. The video decoding method of claim 14, wherein decoding said at least one second video subset bitstream further comprises:
performing decoding of a second AP frame to generate a second decoded AP frame, wherein decoding of the second AP frame is later than decoding of the first AP frame, and said one AP frame is the second AP frame.

17. A video decoding apparatus for decoding a multi-plane video bitstream, the multi-plane video bitstream comprising a first video subset bitstream corresponding to a fundamental plane (FP) and at least one second video subset bitstream corresponding to at least one augmented plane (AP), the video decoding apparatus comprising:
a video decoding circuit, arranged to:
decode the first video subset bitstream, comprising:
performing decoding of a first FP frame to generate a first decoded FP frame; and
decode said at least one second video subset bitstream, comprising:
performing decoding of a first AP frame to generate a first decoded AP frame; and
a resampling circuit, arranged to perform resampling of one decoded FP frame to generate one resampled frame, wherein said one resampled frame serves as one reference frame for decoding one AP frame;
wherein a processing time of performing resampling of said one decoded FP frame overlaps at least one selected from a group of a processing time of performing decoding of the first FP frame and a processing time of performing decoding of the first AP frame.

18. The video decoding apparatus of claim 17, wherein the video decoding circuit comprises:
a single video decoder, wherein the single video decoder is used for performing decoding of the first FP frame, and is re-used for performing decoding of the first AP frame.

19. The video decoding apparatus of claim 17, wherein the video decoding circuit comprises:
a first video decoder, arranged to perform decoding of the first FP frame; and
a second video decoder, arranged to perform decoding of the first AP frame, wherein the first video decoder and the second video decoder are separate decoders.

20. The video decoding apparatus of claim 19, wherein the processing time of performing resampling of said one decoded FP frame overlaps the processing time of performing decoding of the first FP frame, and further overlaps the processing time of performing decoding of the first AP frame.
